(19) United States
(12) Patent Application Publication
(10) Pub. No.: US 2026/0109415 A1
(43) Pub. Date: Apr. 23, 2026

(54) MOTOR VEHICLE BOOT, AND MOTOR VEHICLE COMPRISING SUCH A BOOT

(71) Applicant: STELLANTIS AUTO SAS, Poissy (FR)

(72) Inventors: CYRIL PRACHT, EXINCOURT (FR); ERIC LEMAITRE, BEUTAL (FR); SEBASTIEN MEURANT, ARGIESANS (FR)

(21) Appl. No.: 19/168,719

(22) PCT Filed: Mar. 20, 2024
(86) PCT No.: PCT/FR2024/050344

§ 371 Date: Sep. 24, 2025

(30) Foreign Application Priority Data
Apr. 25, 2023 (FR) FR2304137

(51) Int. Cl. B62D 43/10; B62D 25/08; B62D 43/00; E05B 81/16; E05B 81/54; E05B 83/16

(52) U.S. Cl. CPC B62D 43/10; B62D 25/087; B62D 43/005; E05B 81/16; E05B 81/54; E05B 83/16

(57) ABSTRACT

The invention relates to a trunk (1) for a motor vehicle, comprising:—a lid, movable between an open position and a closed position by means of an electrical control means,—a body structure, comprising a housing (11) adapted to receive a spare wheel (13),—an intermediate floor (15), movable between an open position and a closed position,—a device (25) for locking said intermediate floor, movable by an actuating means between a locking position and an unlocking position allowing said intermediate floor to switch to said open position. According to the invention, said actuating means is controlled by said electrical control means of said trunk, so that when a control signal to open said lid is sent, the locking device switches from said unlocking position to said locking position. The invention also relates to a motor vehicle comprising such a trunk.

### CROSS-REFERENCE TO RELATED APPLICATIONS

This application is the US National Stage under 35 USC § 371 of International Application No. PCT/FR2024/050344, filed Mar. 20, 2024, which claims the priority of French application 2304137 filed on Apr. 25, 2023, the content (text, drawings and claims) of both said applications being incorporated by reference herein.

### BACKGROUND

The devices described herein relate to the field of motor vehicles and more particularly relate to a motor vehicle trunk and a motor vehicle comprising such a trunk.

A motor vehicle typically comprises a storage trunk with a set of trim parts arranged to define a storage space.

A type of motor vehicle trunk known from the prior art comprises a lower floor at the bottom of the trunk, defining a floor bottom.

The lower floor can be fitted with a housing for a “full-size” spare wheel, with dimensions identical to those of the wheels fitted on the motor vehicle, or a “space-saver” spare wheel, with dimensions smaller than those of the wheels fitted on the motor vehicle.

The spare wheel, whether full-size or space-saving size, is fastened to the lower floor by means of a fastening system, for example a well fastened to the lower floor.

In an embodiment known from the prior art, the well is fastened to the lower floor by a plastic screw, enabling quick vertical locking with a plastic nut.

When the motor vehicle is subjected to a head-on collision, the plastic screw has a low pull-out strength, and it has been observed that the plastic screw breaks after 3 to 10 milliseconds, yet the impact lasts 120 milliseconds.

In another embodiment of the prior art, the well is fastened to the lower floor via a metal interface screwed with a nut crimped into the lower floor, or to a welded interface via spot welds.

When the motor vehicle is subjected to a head-on collision, it has been observed that the nut is torn off or the spot welds are peeled off.

As a result, in the event of a head-on collision with a motor vehicle, the fastening system will nearly always come off, regardless of the type of fastening system used.

However, if the spare wheel fastening system comes off in a head-on collision, there is a high risk of the spare wheel being ejected from its housing.

If the spare wheel is ejected from its housing, the spare wheel may impact the rear bench seat of the motor vehicle, causing undesired movements of the rear-seat occupants, which may in turn lead them to impact the front-seat occupants of the motor vehicle or collide with certain components of the motor vehicle.

Also, if the spare wheel is ejected from its housing, it might pass through the trunk cover and strike the occupants of the motor vehicle.

There is thus a need to secure the trunk of the motor vehicle to prevent the spare wheel from impacting the vehicle's occupants in the event of a head-on collision.

Document FR 3 120 225 discloses a motor vehicle trunk comprising a lower floor defining a housing designed to receive a spare wheel. The housing is covered by a trapdoor or intermediate floor, movable between an open position and a closed position concealing the housing that accommodates the spare wheel and capable of being locked and unlocked by means of a locking device operable by a mobile digital terminal.

The purpose of this intermediate floor lock is to prevent the spare wheel stored in the housing of the motor vehicle trunk from being stolen and to secure access to the spare wheel housing, and is not suitable to withstand any mechanical stress on the spare wheel in the event that the motor vehicle experiences a head-on collision.

Furthermore, unlocking the floor locking device requires the use of a mobile digital terminal, which is relatively restrictive for a user.

### SUMMARY

The present devices aim to overcome the aforementioned disadvantages, and to this end relates to a motor vehicle trunk, comprising:
a lid, movable between an open position and a closed position by means of an electrical control means for said lid,
a body structure, comprising a housing adapted to receive a spare wheel,
an intermediate floor, movable between an open position allowing access to said housing and a closed position preventing access to said housing,
a device for locking said intermediate floor to said body structure, movable alternately between a locking position locking said intermediate floor in said closed position and an unlocking position unlocking said intermediate floor allowing said intermediate floor to switch to said open position,
means for actuating said locking device, controlling the switching of said locking device alternately between said locking position and said unlocking position,
notable in that said means for actuating said locking device is controlled by said electrical control means of said trunk, so that when a control signal to open said lid is sent, the locking device switches to said unlocking position, and when a control signal to close said trunk lid is sent, the locking device switches to said locking position.

In the event of the spare wheel fastening system being torn off, for example following a head-on collision of the motor vehicle, the locking device holds the intermediate floor in its closed position, thereby confining the spare wheel within its housing, and consequently avoiding injury to the occupants of the motor vehicle in the event that the spare wheel fastening system comes off.

Also, by having the actuation means of the intermediate floor locking device be controlled by the electrical trunk control means, when a user issues a command to open the trunk, the locking device automatically switches to its unlocked position, enabling the user to access the housing by pivoting the intermediate floor to its open position.

Similarly, when the user has pivoted the intermediate floor into its closed position and issues a command to close the trunk, the locking device automatically switches to its locked position, making the locking device active when the motor vehicle is in use.

According to optional features of the trunk:
said locking device comprises a set of locking lugs;
said locking lugs are retractable;
in one embodiment, said locking lugs are carried by said body structure of said motor vehicle;
in another embodiment, said locking lugs are carried by said intermediate floor;
said means for actuating said locking device can be powered inductively;
said locking lugs are mounted at a rear end of said trunk;
said locking lugs are metallic;
said locking lugs are mounted laterally relative to said intermediate floor, on either side of said intermediate floor.

Further related herein is a motor vehicle comprising a trunk.

### BRIEF DESCRIPTION OF THE FIGURES

Further features, aims and advantages will become apparent from the following detailed description, which will be understood with reference to the appended drawings in which:

FIG. 1 is a side view showing schematically a motor vehicle trunk, with the intermediate floor illustrated in the open position.

FIG. 2 shows a rear view of the trunk, with the intermediate floor in the closed position.

### DETAILED DESCRIPTION

In the remainder of the description, elements with identical structures or similar functions are designated by the same reference.

By convention, and without limitation, the terms longitudinal, vertical, and transverse are defined with reference to a right-handed trihedron (L, V, T) corresponding respectively to the longitudinal, vertical, and transverse axes of the vehicle.

In the following, the terms “front”, “rear”, “left”, “right”, “lower” and “upper” are with respect to the vehicle.

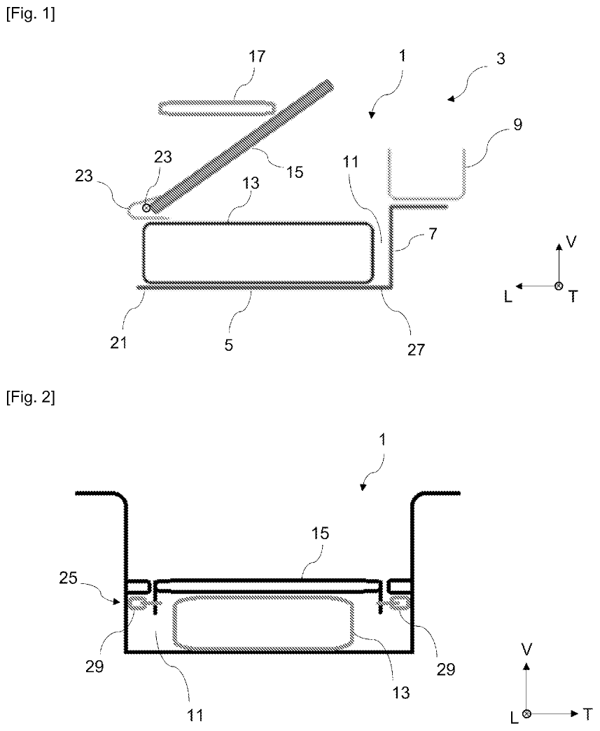

Reference is made to FIG. 1, which schematically shows in side view an example of a motor vehicle 3 trunk 1.

The motor vehicle 3 is a vehicle with a combustion engine, one or more electric motors or else a hybrid vehicle with a combustion engine and one or more electric motors.

The trunk 1 has a longitudinal median plane of symmetry. As such, the description given for a left-hand part of trunk 1 applies by analogy to the right-hand part of trunk 1, and vice versa.

The lower part of the trunk 1 comprises a lower floor 5, also known as the “floor bottom”, which forms part of a body structure 7 of the motor vehicle.

Access to the trunk 1 from outside the motor vehicle 3 is via a lid 9, which may be a trunk door or a tailgate.

The lid 9 can be alternatively opened or closed by means of an electrical control device.

The body structure 7 comprises a housing 11 or compartment, adapted to receive, for example, a spare wheel 13 intended to be fastened to the lower floor 5. Optionally, the lower floor 5 can accommodate a toolbox (not shown) containing tools for replacing a motor vehicle wheel.

The spare wheel 13 may be a “full-size” spare wheel, with dimensions identical to those of the wheels fitted on the motor vehicle, or a “space-saver” spare wheel, with dimensions smaller than those of the wheels fitted on the motor vehicle.

The spare wheel 13 is fastened to the lower floor 5 by means of a fastening system not shown in the figures, comprising, for example, a well fastened to the lower floor 5.

The trunk 1 further comprises a removable intermediate floor 15, which can be a “two-position” floor, and a cover 17 that can be used to conceal the contents of the trunk 1.

As shown in FIG. 1, the intermediate floor 15 can be made from a single piece extending along the entire length of the trunk 1. In a variant not illustrated, the intermediate floor 9 comprises two subfloors articulated together via a hinge.

The intermediate floor 15 is also mounted on the body structure by means of two side engagement mountings 19 mounted on either side of the intermediate floor 15 near a front end 21 of the trunk 1.

The presence of the side engagement mountings 19 makes it possible to prevent the intermediate floor 15 from moving relative to a longitudinal axis of the motor vehicle 3, while allowing the angular displacement of the intermediate floor relative to a transverse axis of the motor vehicle 3.

In this way, the intermediate floor 15 can be moved between an open position shown in FIG. 1 and a closed position shown in FIG. 2.

In its open position, the intermediate floor 15 allows access to the housing 11. Furthermore, in its open position, the intermediate floor 15 has pivoted about a substantially transverse axis 23 of the motor vehicle 3 passing through the side engagement mountings 19.

FIG. 2 shows a schematic view of the rear of trunk 1, with the intermediate floor 15 in the closed position.

When the intermediate floor 15 is in the closed position, the intermediate floor 15 is in a substantially horizontal position relative to the motor vehicle 3, thus preventing access to the housing 11.

When the intermediate floor 15 is in its closed position, a user of the motor vehicle 3 can place luggage or other packages in the trunk 1 on the intermediate floor 15.

The trunk 1 comprises a locking device 25 for the intermediate floor 15, designed to lock the intermediate floor 15 in its closed position when locking device 25 is in a locking position, and to unlock the intermediate floor 15 when the locking device 25 is in an unlocking position, thus allowing the intermediate floor 15 to switch to its open position.

The locking device 25 is arranged in the trunk 1 to prevent the intermediate floor 15 from pivoting about its axis 23, in particular when the spare wheel 13 fastening system is pulled off due to a head-on collision, when the locking device is in its locked position.

For this purpose, the locking device is, for example, mounted near a rear end 27 of the trunk 1 (visible in FIG. 1).

The locking device 25 is moved back and forth between its locking and unlocking positions by a motorized actuator (not shown).

The means for actuating the locking device 25 is controlled by the electrical control means of the trunk 1, so that when a control signal to open the trunk is sent, the locking device 25 switches to its unlocked position, and when a control signal to close the trunk 1 is sent, the locking device 25 switches to its locked position.

Thus, when a user issues a command to open the trunk 1, the locking device 25 automatically switches to its unlocked position, enabling the user to access the housing 11 by pivoting the intermediate floor 15 into its open position.

When the user has pivoted the intermediate floor 15 into its closed position and issues a command to close the trunk 1, the locking device 25 automatically switches to its locked position.

In the example shown in FIG. 2, the locking device 25 comprises two locking lugs 29. However, in a variant not shown, more locking lugs 29 can be fitted to the locking device 25.

The locking lugs 29 are sized to retain the force applied by the spare wheel 13 in the event of the spare wheel 13 securing system being pulled off, for example if the motor vehicle experiences a head-on collision.

For example, the locking lugs 29 are made of metal, which provides good resistance to the stresses placed on the spare wheel 13 when its fastening system is pulled off.

The locking lugs 29 are, for example, retractable lugs.

In one embodiment, the locking lugs 29 are mounted laterally relative to the intermediate floor, on either side of the intermediate floor 15.

The locking lugs 29, for example, are carried by the body structure 7 of the motor vehicle, and are fastened to the intermediate floor 15 to lock the intermediate floor 15 when the locking device 25 occupies its locking position. In this way, the user is spared the need to disconnect the means for actuating the locking lugs 29 when he wishes to remove the intermediate floor 15, for example to remove the spare wheel 13 or clean the lower floor 5.

According to a variant not shown, the locking lugs 29 are carried by the intermediate floor 15 and are fastened to the body structure 7 to lock the intermediate floor 15 when they occupy their locking position.

In this case, the motorized means for actuating the locking device 25 can be powered inductively.

In one embodiment, the locking lugs 29 are, for example, mounted close to the rear end 27 of the trunk 1.

It goes without saying that the described devices are not limited solely to the embodiments of this motor vehicle trunk and of this motor vehicle comprising such a trunk, described above solely through illustrative examples; rather, they encompass all variants involving the technical equivalents of the means described as well as their combinations if they fall within the described scope.

1. A trunk for a motor vehicle, comprising:
a lid, movable between an open position and a closed position by means of an electrical control means for said lid,
a body structure, comprising a housing adapted to receive a spare wheel,
an intermediate floor, movable between an open position allowing access to said housing and a closed position preventing access to said housing,
a device for locking said intermediate floor to said body structure, movable alternately between a locking position locking said intermediate floor in said closed position and an unlocking position unlocking said intermediate floor allowing said intermediate floor to switch to said open position,
means for actuating said locking device, controlling the switching of said locking device alternately between said locking position and said unlocking position,
wherein said means for actuating said locking device is controlled by said electrical control means of said trunk, so that when a control signal to open said lid is sent, the locking device switches to said unlocking position, and when a control signal to close said trunk lid is sent, the locking device switches to said locking position.

2. The trunk according to claim 1, wherein said locking device comprises a set of locking lugs.

3. The trunk according to claim 2, wherein said locking lugs are retractable.

4. The trunk according to claim 2, wherein said locking lugs are carried by said body structure of said motor vehicle.

5. The trunk according to claim 2, wherein said locking lugs are carried by said intermediate floor.

6. The trunk according to claim 2, wherein said means for actuating said locking device is powered inductively.

7. The trunk according to claim 2, wherein said locking lugs are mounted at a rear end of said trunk.

8. The trunk according to claim 2, wherein said locking lugs are metal.

9. The trunk according to claim 2, wherein said locking lugs are mounted laterally relative to said intermediate floor, on either side of said intermediate floor.

10. A motor vehicle comprising said trunk is according to claim 1.
